(19) United States
(12) Patent Application Publication
(10) Pub. No.: US 2010/0131261 A1
(43) Pub. Date: May 27, 2010

(54) INFORMATION RETRIEVAL ORIENTED TRANSLATION METHOD, AND APPARATUS AND STORAGE MEDIA USING THE SAME

(75) Inventors: Ken-Yu Lin, Taipei City (TW); Shang-Hsien Hsieh, Taipei City (TW); Hsien-Tang Lin, Taipei City (TW)

Correspondence Address: QUINTERO LAW OFFICE, PC, 615 Hampton Dr, Suite A202, Venice, CA, 90291, US

(73) Assignee: NATIONAL TAIWAN UNIVERSITY, TAIPEI (TW)

(21) Appl. No.: 12/479,459

(22) Filed: Jun. 5, 2009

(30) Foreign Application Priority Data
Nov. 25, 2008 (TW) TW97145471

(51) Int. Cl. G06F 17/28; G06F 17/21

(52) U.S. Cl. 704/7; 704/10; 704/E15.003

(57) ABSTRACT

An information retrieval translation apparatus for translating a plurality of Chinese terms including a first Chinese term and a second Chinese term is disclosed. The information retrieval oriented translation apparatus includes a first language database, a second language database, a comparison module and a translation term acquisition module. The first language database stores a plurality of first indices and a plurality of corresponding first translation terms. The second language database stores a plurality of second indices and a plurality of corresponding second translation terms. The comparison module compares the first and second Chinese terms with the first and second indices, respectively. The translation term acquisition module acquires the corresponding first translation term for the first index which corresponds to the first Chinese term, and the corresponding second translation term for the second index which corresponds to the second Chinese term.

This Application claims priority of Taiwan Patent Application No. 97145471, filed on Nov. 25, 2008, the entirety of which is incorporated by reference herein.

### BACKGROUND OF THE INVENTION

1. Field of the Invention

The invention relates generally to a translation method and apparatus and storage media using the same, and more particularly, to a translation method and apparatus and storage media using the same for cross-language information retrieval.

2. Description of the Related Art

With increased internet access, information retrieval via the internet has grown in popularity. Accordingly, cross-language information retrieval has also grown in popularity. For cross-language information retrieval, one conventional method is for manual translation of information in advance and another conventional method is for key term translation of information.

While manual translation of information in advance results in better quality translations, feasibility due to high costs hinders usage. Meanwhile, key term translation of information, while more feasible than manual translations, is characterized by lower quality translations and decreased usefulness.

### BRIEF SUMMARY OF THE INVENTION

The invention discloses an information retrieval translation method for translating a plurality of Chinese terms comprising a first Chinese term and a second Chinese term. The information retrieval translation method comprises comparing the first Chinese term with a plurality of first indices stored in a first language database, wherein the first language database has a plurality of first translation terms corresponding to the first indices. Additionally, the corresponding first translation term for the first index which corresponds to the first Chinese term is acquired. Also, the second Chinese term with a plurality of second indices stored in a second language database is compared, wherein the second language database has a plurality of second translation terms corresponding to the second indices. Moreover, the corresponding second translation term for the second index which corresponds to the second Chinese term is acquired.

Furthermore, the invention discloses an information retrieval translation apparatus for translating a plurality of Chinese terms comprising a first Chinese term and a second Chinese term. The information retrieval translation apparatus comprises a first language database, a second language database, a comparison module and a translation term acquisition module. The first language database stores a plurality of first indices and a plurality of first translation terms corresponding to the first indices. The second language database stores a plurality of second indices and a plurality of second translation terms corresponding to the second indices. The comparison module compares the first Chinese term with the first indices, and the second Chinese term with the second indices. The translation term acquisition module acquires the corresponding first translation term for the first index which corresponds to the first Chinese term, and the corresponding second translation term for the second index which corresponds to the second Chinese term.

Furthermore, the invention discloses a storage medium for storing an information retrieval translation program, wherein the information retrieval translation program comprises a plurality of program codes to be loaded onto a computer system so that an information retrieval translation method for translating a plurality of Chinese terms comprising a first Chinese term and a second Chinese term may be executed by the computer system. The information retrieval translation method comprises comparing the first Chinese term with a plurality of first indices stored in a first language database, wherein the first language database has a plurality of first translation terms corresponding to the first indices. Additionally, the corresponding first translation term for the first index which corresponds to the first Chinese term is acquired. Also, the second Chinese term with a plurality of second indices stored in a second language database is compared, wherein the second language database has a plurality of second translation terms corresponding to the second indices. Moreover, the corresponding second translation term for the second index which corresponds to the second Chinese term is acquired.

### BRIEF DESCRIPTION OF THE DRAWINGS

The invention can be more fully understood by reading the subsequent detailed description and examples with references made to the accompanying drawings, wherein:

FIG. 1 shows a diagram of an information retrieval translation apparatus according to an embodiment of the invention;

FIG. 2 shows an operation flowchart of the information retrieval translation apparatus according to an embodiment of the invention; and

FIG. 3 shows an information retrieval translation flowchart according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

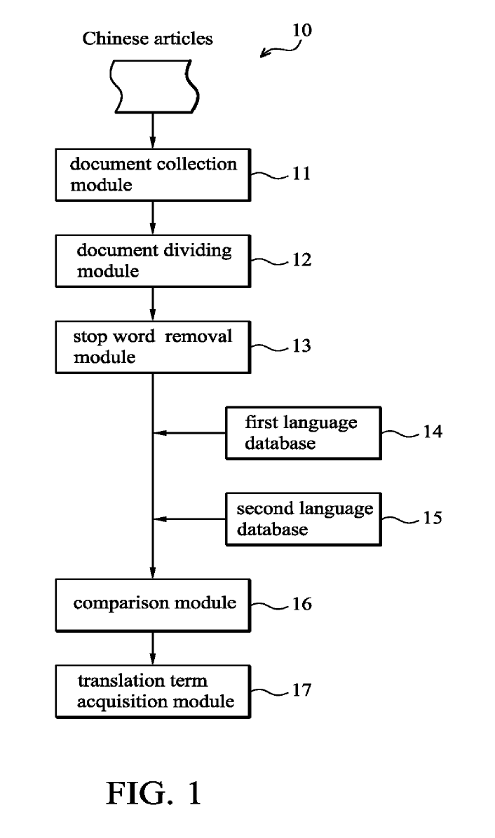

FIG. 1 shows a diagram of an information retrieval translation apparatus according to an embodiment of the invention. The information retrieval translation apparatus 10 comprises a document collection module 11, a document dividing module 12, a stop word removal module 13, a first language database 14, a second language database 15, a comparison module 16 and a translation term acquisition module 17.

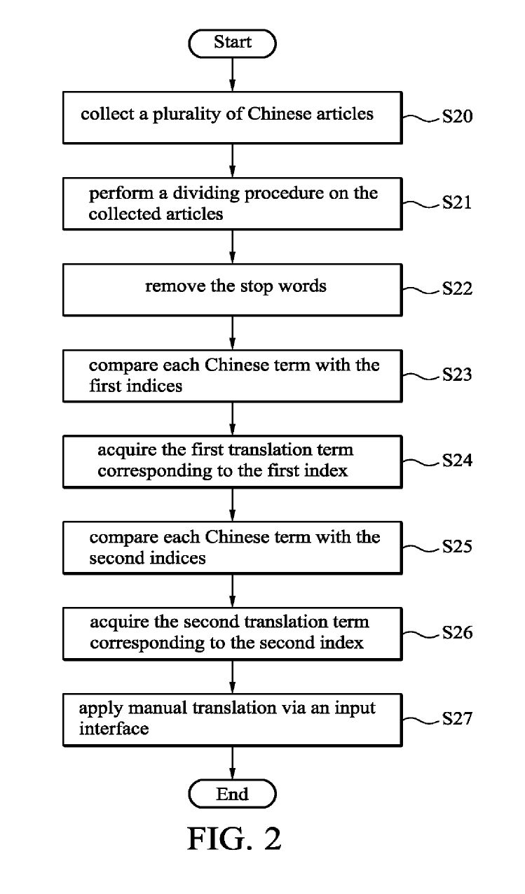

FIG. 2 shows an operation flowchart of the information retrieval translation apparatus according to an embodiment of the invention. First, the document collection module 11 collects a plurality of Chinese articles (step S20). Assume that one of the plurality of Chinese articles is “ji yu jing fei bian lie ji jin kuai jin xing nai zhen ping gu bu qiang gong zuo zhi kao liang [symbol] [symbol] [symbol] ying jian li yi chu bu ping gu fang fa [symbol] [symbol] ′ and yi zuo wei chu bu shai xuan you xian jin xing nai zhen neng li bu qiang zhi xiao she jian zhu [symbol] [symbol] [symbol] ”, the document dividing module 12 performs a dividing procedure on the collected Chinese articles (step S21). For example, a list of produced Chinese terms for the above divided article may be seen in Table 1 below:

TABLE 1
List of Chinese Terms For a Divided Article

ji yu [symbol] jing fei [symbol] bian lie [symbol] ji [symbol] jin kuai [symbol] jin xing [symbol]
nai zhen [symbol] ping gu [symbol] bu qiang [symbol] gong zuo [symbol] zhi [symbol]
kao liang [symbol] , ying [symbol] jian li [symbol] yi [symbol] chu bu [symbol] ping
gu [symbol] fang fa [symbol] , yi [symbol] zuo wei [symbol] chu bu [symbol] shai
xuan [symbol] you xian [symbol] jin xing [symbol] nai zhen [symbol] neng li [symbol]
bu qiang [symbol] zhi [symbol] xiao she [symbol] jian zhu

[symbol]

Next, the stop word removal module 13 removes the stop words from the Table 1 (step S22). The stop words refer to as the unimportant terms and punctuation marks, such as “ji [symbol] “zhi [symbol] ” “yi [symbol] ” “yi (AA)” [symbol] ” and “ying [symbol] . Based on this, the remaining Chinese terms may be seen as Table 2 below:

TABLE 2
List of Chinese Terms Without Stop Words

ji yu [symbol] jing fei [symbol] bian lie [symbol] jin kuai [symbol] jin xing [symbol]
nai zhen [symbol] ping gu [symbol] bu qiang [symbol] gong zuo [symbol] kao liang [symbol]
jian li [symbol] chu bu [symbol] ping gu [symbol] fang fa [symbol] zuo wei [symbol]
chu bu [symbol] shai xuan [symbol] you xian [symbol] jin xing [symbol] nai
zhen [symbol] neng li [symbol] bu qiang [symbol] xiao she [symbol] jian zhu

[symbol]

The content of Table 2, is next utilized to apply the information retrieval translation method of the invention. The first language database 14 is first used to translate the content of Table 2. The first language database 14 may be a general dictionary for general translations rather than professional dictionary for professional translations. In addition, the first language database 14 stores a plurality of first indices and a plurality of first translation terms corresponding to the first indices. For example, a first index may be “jian li [symbol] whereas a translation term corresponding to the first index may be “establish”, “create” or “build”. Note “jian li” is merely a phonetic transcription (pinyin) for the Chinese characters [symbol] (jian li)”, and not an English translation, which is “establish”, “create” or “build”.

Following, the comparison module 16 compares each Chinese term of Table 2 with the first indices stored in the first language database 14 (general dictionary) (step S23). If a first index is found corresponding to the Chinese term of Table 2, the translation term acquisition module 17 acquires the first translation term corresponding to the first index (step S24).

Through the processing of steps S23 and S24, the result may be seen as the Table 3 below:

TABLE 3
Translation Result Provided By General Dictionary

“ji yu [symbol] ” “funds” “bian lie [symbol] “as soon as possible” “to advance”
“nai zhen [symbol] seismic” “evaluate” “bu qiang [symbol] ” “job” “consider”
“ought” “establish (or create, build)” “initial” “evaluate” “method”
“accomplish” “initial” “to filter” “priority” “to advance” “nai zhen [symbol]
seismic” “capability” “bu qiang [symbol] ” “xiao she [symbol] ” “architecture”

As seen in Table 3, the remaining Chinese terms were not translated. Therefore, a professional dictionary (second language database 15) is used for a better quality translation.

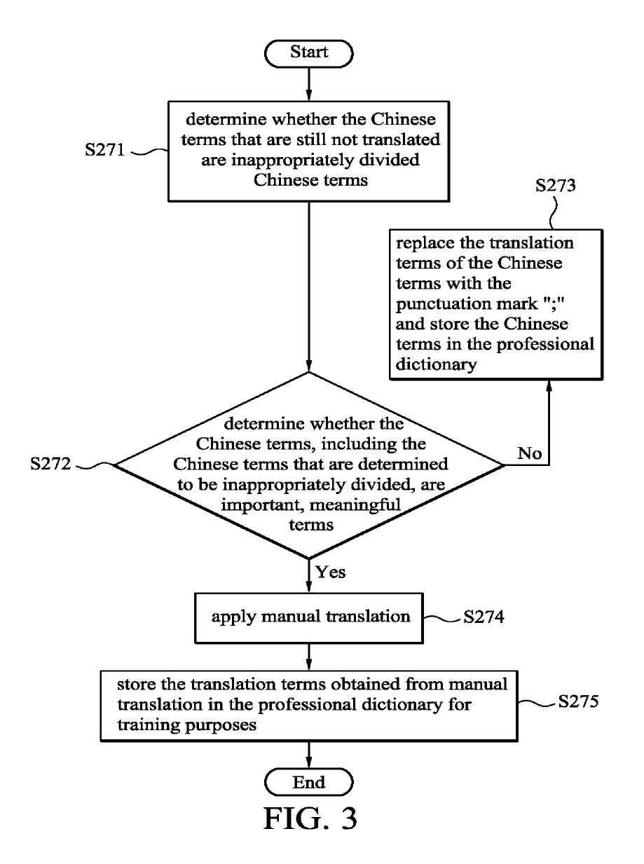

Following, the comparison module 16 compares the Chinese terms that were not translated with the second indices stored in the second language database 15 (professional dictionary) (step S25). Note that the second language database 15 also stores a plurality of second indices and a plurality of second translation terms corresponding to the second indices. Following step S25, if a second index is found corresponding to the Chinese terms that were not translated, then the translation term acquisition module 17 acquires the corresponding second translation term stored in the second language database 15 (step S26). With steps S25 and S26, the Chinese term “bu qiang [symbol] of Table 3 may be translated as “reinforcement”. However, some Chinese terms may still not be translated, such as “ji yu [symbol] , “bian lie [symbol] , “nai zhen [symbol] and “xiao she [symbol] ”. Thus, manual translation is applied via an input interface (not shown), such as a keyboard or a mouse etc (step S27). Detailed description of the step S27 is explained with reference to FIG. 3.

FIG. 3 shows an information retrieval translation flowchart for the step S27 according to an embodiment of the invention. The translation result illustrated in step S26 is provided by both the general and professional dictionaries. If there are still Chinese terms that are not translated following the translation result illustrated in step S26, the Chinese terms are processed and recorded for manual translation thereafter. Specifically, first, it is determined whether the Chinese terms that are still not translated are inappropriately divided Chinese terms for step S21 (step S271). For example, a Chinese sentence “quan tai da ting dian [symbol] may be inappropriately divided as “quan [symbol] )”, “tai da [symbol] and “ting dian [symbol] (the correct dividing should be “quan tai [symbol] “da [symbol] and “ting dian [symbol] Next, it is determined whether the Chinese terms, including the Chinese terms that are determined to be inappropriately divided, are important, meaningful terms (step S272). If not, the translation terms of the Chinese terms will be replaced with the punctuation mark “;” and the Chinese terms are further stored in the professional dictionary (step S273) so that the same unimportant Chinese terms may be skipped in future information retrieval. If the Chinese terms are determined to be important, meaningful terms, manual translation is applied (step S274). Note that if the Chinese terms determined to be inappropriately divided are also determined to be important and meaningful, the inappropriate dividing is manually corrected before the manual translation is applied. The definition of important, meaningful terms is dependent of whether the Chinese terms are critical for information retrieval. For instance, for the Chinese terms that are not translated following the translation result illustrated in step S26, the Chinese term “bian lie [symbol] is usually not treated as a critical term for any specific field. Therefore, it is determined to be an unimportant term and its translation term is replaced with the punctuation mark “;”. Meanwhile, the Chinese term “nai zhen [symbol] is a commonly-used term in architectural engineering, so it is regarded as an important, meaningful term. Therefore, it is translated as “earthquake resistant” following manual translation, and the translation term “earthquake resistant” is further stored in the professional dictionary through the input interface. Also, the Chinese term “xiao she [symbol] represents a specific object, which is determined to be an important, meaningful term. Therefore, it is translated as “school building” following manual translation and the translation term “school building” is further stored in the professional dictionary through the input interface. As for the Chinese term “ji yu [symbol] it is also determined to be an important, meaningful term since it involves the concept of cause and effect. Therefore, it is translated as “because of” following manual translation and the translation term “because of” is further stored in the professional dictionary through the input interface.

The content of Table 3 may be translated as Table 4 using the rule introduced in FIG. 3, as shown below:

TABLE 4
Translation Result Using General And Professional Dictionaries
As Well As Human Translation

“because of” “funds” “as soon as possible” “to advance” “earthquake
resistant seismic” “evaluate” “reinforcement” “job” “consider” “ought”
“establish (or create, build)” “initial” “evaluate” “method”
“accomplish” “initial” “to filter” “priority” “to advance” “earthquake
resistant seismic” “capability” “reinforcement” “school building”
“architecture”

When compared to a translation result using only manual translation: “when considering costs and expedience of assuring seismically standard school buildings, a preliminary seismic evaluation should first be conducted to prioritize the retrofitting of school buildings”, despite differences in the quality of translation as illustrated in Table 4, listing of the key terms for cross-language information retrieval is achieved, thus providing substantially the same performance as the manual translation for information retrieval.

Note that during application, training of key term(s) is applied in the information retrieval translation method of the invention to achieve more expedient cross-language information retrieval.

Note that in step S273, the translation terms of the unimportant Chinese terms are directly replaced with the punctuation mark “;” without translation and these Chinese terms are stored in the professional dictionary. Thus, training of the professional dictionary is achieved, decreasing time required for future processing. Similarly, in step S274, the translation terms obtained from manual translation will also be stored in the professional dictionary for training purposes (step S275). Thus, the translation for the same Chinese term may be directly obtained from the professional dictionary without repeated manual translations, thus decreasing future requirement for manual translations and costs and increasing quality of translations.

In addition, the information retrieval translation method can be recorded as a program in a storage medium for performing the above procedures, such as an optical disk, floppy disk and portable hard drive and so on. It is to be emphasized that the information retrieval translation method program is formed by a plurality of program codes corresponding to the procedures described above.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An information retrieval translation method for translating a plurality of Chinese terms comprising a first Chinese term and a second Chinese term, comprising:
comparing the first Chinese term with a plurality of first indices stored in a first language database, wherein the first language database has a plurality of first translation terms corresponding to the first indices;
acquiring the corresponding first translation term for the first index which corresponds to the first Chinese term;
comparing the second Chinese term with a plurality of second indices stored in a second language database, wherein the second language database has a plurality of second translation terms corresponding to the second indices; and
acquiring the corresponding second translation term for the second index which corresponds to the second Chinese term.

2. The information retrieval translation method as claimed in claim 1, wherein the Chinese terms further comprise a third Chinese term.

3. The information retrieval translation method as claimed in claim 2, further comprising acquiring a translation term corresponding to the third Chinese term through an input interface.

4. The information retrieval translation method as claimed in claim 1, wherein the first language database is a general dictionary, and the second language database is a professional dictionary.

5. The information retrieval translation method as claimed in claim 1, wherein the first language database is different from the second language database.

6. An information retrieval translation apparatus for translating a plurality of Chinese terms comprising a first Chinese term and a second Chinese term, comprising:
a first language database storing a plurality of first indices and a plurality of first translation terms corresponding to the first indices;
a second language database storing a plurality of second indices and a plurality of second translation terms corresponding to the second indices;
a comparison module comparing the first Chinese term with the first indices, and the second Chinese term with the second indices; and
a translation term acquisition module acquiring the corresponding first translation term for the first index which corresponds to the first Chinese term, and the corresponding second translation term for the second index which corresponds to the second Chinese term.

7. The information retrieval translation apparatus as claimed in claim 6, wherein the Chinese terms further comprise a third Chinese term.

8. The information retrieval translation apparatus as claimed in claim 7, further comprising an input interface acquiring a translation term corresponding to the third Chinese term.

9. The information retrieval translation apparatus as claimed in claim 6, wherein the first language database is a general dictionary, and the second language database is a professional dictionary.

10. The information retrieval translation apparatus as claimed in claim 6, wherein the first language database is different from the second language database.

11. A storage medium for storing an information retrieval translation program, wherein the information retrieval translation program comprises a plurality of program codes to be loaded onto a computer system so that an information retrieval translation method for translating a plurality of Chinese terms comprising a first Chinese term and a second Chinese term may be executed by the computer system, and the information retrieval translation method comprises:
comparing the first Chinese term with a plurality of first indices stored in a first language database, wherein the first language database has a plurality of first translation terms corresponding to the first indices;
acquiring the corresponding first translation term for the first index which corresponds to the first Chinese term;
comparing the second Chinese term with a plurality of second indices stored in a second language database, wherein the second language database has a plurality of second translation terms corresponding to the second indices; and
acquiring the corresponding second translation term for the second index which corresponds to the second Chinese term.

12. The storage medium as claimed in claim 11, wherein the Chinese terms further comprise a third Chinese term.

13. The storage medium as claimed in claim 12, wherein the information retrieval translation method further comprises acquiring a translation term corresponding to the third Chinese term through an input interface.

14. The storage medium as claimed in claim 11, wherein the first language database is a general dictionary, and the second language database is a professional dictionary.

15. The storage medium as claimed in claim 11, wherein the first language database is different from the second language database.
